(19) United States
(12) Patent Application Publication
(10) Pub. No.: US 2010/0070639 A1
(43) Pub. Date: Mar. 18, 2010

(54) Network Clone Detection

(75) Inventor: Stuart A. Hoggan, Longmont, CO (US)

Correspondence Address: DAVIS WRIGHT TREMAINE LLP - San Francisco, 505 MONTGOMERY STREET, SUITE 800, SAN FRANCISCO, CA, 94111, US

(73) Assignee: Cable Television Laboratories, Inc., Louisville, CO (US)

(21) Appl. No.: 12/209,987

(22) Filed: Sep. 12, 2008

(51) Int. Cl. G06F 15/16

(52) U.S. Cl. 709/229

(57) ABSTRACT

Each client device among a group of client devices whose access to a network is controlled by the same Network Access Control server will have a unique physical address. However, the same physical address may exist among a group of client devices controlled by different Network Access Control server. To detect and block clone devices from obtaining service, each Network Access Control server will have its own identifier and this identifier is one of the authorization parameters used by the Dynamic Host Configuration Protocols server for determining whether the request for an IP address is from an authorized client device.

### BACKGROUND OF THE INVENTION

This invention relates in general the detection of clone devices on the network, and more particularly to the detection of clone devices on Internet Protocol (IB) Networks used for delivering media content.

In cable systems, such as cable systems using the Data Over Cable Service Interface Specifications (DOCSIS), cable service to cable modems located at customers' locations is provided by a number of cable modem termination systems (“CMTS”), where each CMTS is responsible for providing service to a group of the cable modems. The cable modem is authorized for service by a customer service representative using its Media Access Control (“MAC”) address for identification. In order for the customer to obtain cable service, this MAC address is provided by the cable modem to a Dynamic Host Configuration Protocol (“DHCP”) server. If the MAC address provided by the cable modem appears to be valid, the DHCP server will then provide an Internet Protocol (“IP”) address to the cable modern. The cable modem may then be able to access the media content on the IP network using the IP address provided by the DHCP server.

Thus, each CMTS provides service to a group of cable modems each with its own MAC address, where the group of cable modems and their MAC addresses is known as a media access layer domain or simply domain. In most cable systems, such as the ones adopting DOCSIS, no duplicate MAC address is allowed to exist within a domain, so that each MAC address uniquely identifies a corresponding cable modem in the domain. The CMTS does not allow cable modem MAC addresses to be duplicated within its domain. However, the same MAC address may exist in different domains. It is discovered that this has become the back door through which hackers using clone devices may be able to steal cable service. For example, a hacker fraudulently obtains the MAC address of an authorized cable modem, and submits this MAC address using a clone device in a different domain to the DHCP server to obtain an IP address. Since the DHCP server cannot tell the difference between an authorized or cloned MAC address it assigns an IP address which allows the clone device to steal cable service without payment. While multi-system operators (“MSO”) have installed centralized monitoring tools for detecting clone cable modems, the tool is unable to determine which cable modem is an authorized one belonging to a paying customer. It is therefore desirable to provide a solution whereby such clones can be detected and their access blocked automatically.

Media content is now delivered through IP networks operated by media operators other than cable systems, such as Internet Protocol Television (“IPTV”) or still other types of IP networks. Thus, more generally, access to media content delivered through IP networks such as a cable or IPTV network may be controlled by Network Access Control (“NAC”) Servers. Each NAC server may control access to an IP network by a corresponding group of devices, each with a unique physical address. Since two different devices serviced by two different NAC servers may have the same physical address, it is again possible for hackers using clone devices to steal media content in a manner analogous to the one described above for cable systems. It is therefore desirable to provide a solution whereby such fraud may be prevented or reduced.

### SUMMARY OF THE INVENTION

In one embodiment, fraud can be reduced or prevented by providing an identifier for each NAC server. When such server receives a request from a client device for an IP address, the NAC server will then transmit the request together with its own identifier to a DHCP server. This will then allow the DHCP server to identify whether the request from the client device is one from a legitimate client device instead of one from an unauthorized client device, such as a clone.

In another embodiment of the invention, when a request from a client device is received from an NAC server together with the identifier of the NAC server, it is determined from the identifier and the physical address of the client device whether the client device is an authorized client device. An IP address is provided to the client device only when it is determined that the client device is one which is authorized.

In yet another embodiment of the invention, a system for providing an IP address for a client device to access information on a network comprises one or more NAC servers each having an identifier and controlling access to the network. This system also includes a DHCP server. Each of the NAC servers transmits requests for IP addresses from client devices with the identifier of such NAC server to the DHCP server. The DHCP server determines from the received identifier and physical address whether such client device is authorized. The DHCP server sends an IP address to such client device only when it is determined that the client device is authorized.

Features in the above embodiments may be used individually or in combination.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a block diagram of a system including an IP network used for delivery of media content to illustrate one embodiment of the invention.

FIG. 2 is a flow diagram illustrating the operation of the system of FIG. 1.

For simplicity in description, identical components are labeled by the same numerals in this application.

### DETAILED DESCRIPTION OF EXEMPLARY EMBODIMENTS

Thus in general, media content or other services may be delivered through an IP network under the control of a number of Network Access Control (“NAC”) servers. Each of the client devices serviced (including access control) by each NAC server has a unique address among the group of client devices serviced by such server. However, different client devices serviced by different NAC servers may have the same physical address so that hackers may be able to steal service by fraudulently obtaining the physical address of a legitimate client device and send such address to the DHCP server to obtain an IP address.

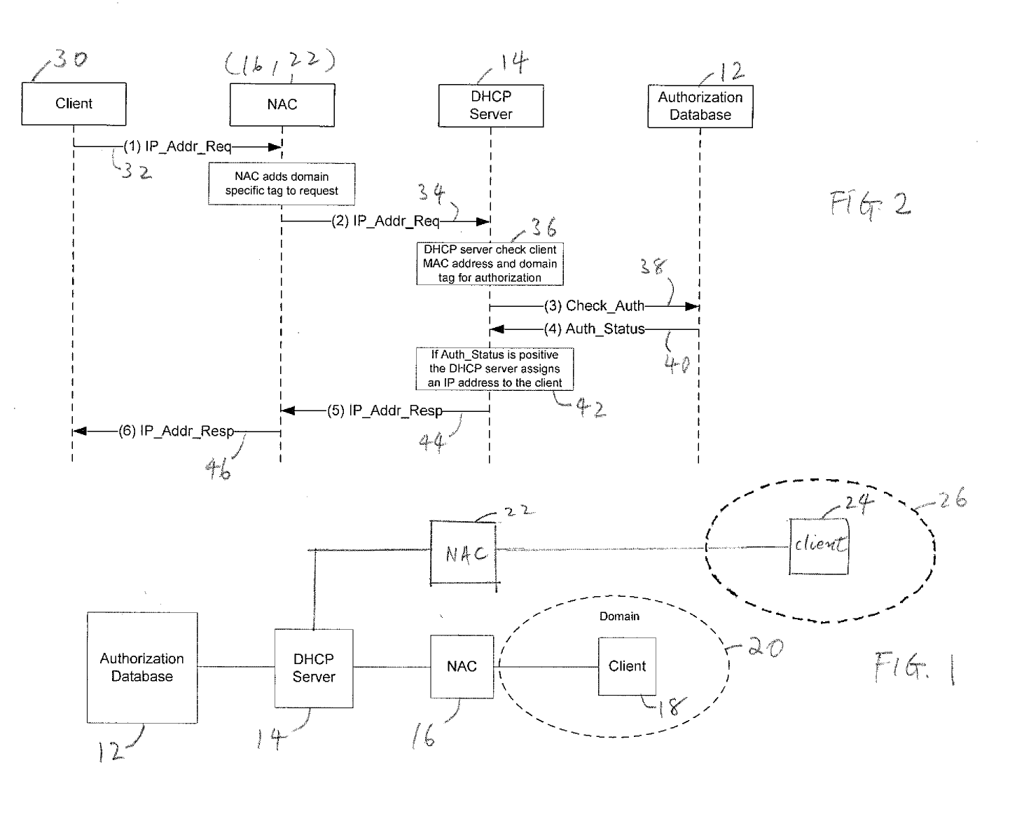

To solve the problem above, the physical address (such as the MAC address) and the identifier of the NAC server controlling access by such client device (referred to herein as the associated NAC server) are both used to determine whether such client device should be allowed access to the network. In the case of cable systems, this identifier may be a media access layer domain number of the media access layer domain serviced and controlled by a particular CMTS. This physical address and the associated identifier of the NAC server are then stored (e.g. as a pair) in an authorization database 12 shown in FIG. 1 for the purpose of uniquely identifying the particular client device across different domains. The DHCP server 14 has access to the database 12, and makes the determination as to whether a request for an IP address from a client device should be granted.

As shown in FIG. 1, access to content on an IP network (not shown) is controlled by a number of NAC servers such as servers 16 and 22. Server 16 controls access to the network by representative client device 18, as well as by many other client devices not shown within the group 20. Where the IP network is a cable network, server 16 is a CMTS which controls access to the cable network by representative cable modem 18, as well as by many other cable modems not shown, in domain 20. Server 22 controls access to the network by representative client device 24, as well as by many other client devices not shown within the group 26. Where the IP network is a cable network, server 22 is a CMTS which controls access to the cable network by representative cable modem 24, as well as by many other cable modems not shown, in domain 26. While only two NAC servers are illustrated in FIG. 1, it will be understood that typically there will be many more NAC servers, each controlling access by its own corresponding group of client devices.

The NAC server (e.g. server 16 or 22) provides service to and control access by a group of client devices such as client device 18 or 24. Each of the servers 16 and 22, and each of all other NAC servers not shown in FIG. 1 controlling access to the same IP network, has a unique identifier (a media access layer domain identifier, or MDI, in the case of cable systems) which is different from the identifier of all other NAC servers in the IP network. As noted above, when a customer using client device 18 signs up for a service, a customer service representative will authorize the physical address (such as a MAC address in the case of cable systems) of the client device, and this authorized physical address and the NAC server identifier of server 16 are then stored in database 12. The physical addresses of other client devices controlled by server 16 not shown in FIG. 1 are authorized in a similar manner and are stored in database 12 with the identifier of server 16. Similarly, when a customer using client device 24 signs up for a service, a customer service representative will authorize the physical address of the client device, and this authorized physical address and the identifier of NAC server 22 are then stored in database 12. The physical addresses of other client devices controlled by server 22 not shown in FIG. 1 are authorized in a similar manner and are stored in database 12 with the identifier of server 22.

When one of the NAC servers (such as server 16 or 22) controlling access to the IP network receives a requests for an IP address along arrow 32 from a client device 30 as shown in FIG. 2, the NAC server will add its own identifier to the request and send the request to the DHCP server 14 along arrow 34. The DHCP server will then check both the physical address of the client device 30 as well as the identifier of the NAC server against the information on authorized client devices and their associated identifiers of NAC servers in database 12 (block 36) by accessing database along arrow 38. The information sought by the DHCP server is returned by database along arrow 40. In one embodiment, a pair of the physical address of the client device 30 and the associated identifier of the NAC server is sent along arrow 38 along with a request for the database 12 to check whether there is a pair in database 12 that matches such pair. In one embodiment, the information sought by the DHCP server is returned by database 12 along arrow 40 as a “yes” or “no” answer to the request received by the database 12. Where the IP network is a cable network, the DHCP server will check the authenticity of the identifier (e.g. identifying number) of the media access layer domain serviced and controlled by the CMTS transmitting the client IP address request and of the MAC address of the requesting client device.

Since each NAC server will have its own unique identifier that is different from the identifiers of all other NAC servers in the same IP network, and since each client device among a group of client devices service controlled by the same NAC server will have its own unique physical address, the physical address together with the identifier will be a unique pair, and will uniquely identify each client device, even though client devices serviced by different NAC servers may have the same physical address. For example, as shown in FIG. 1, client devices 18 and 24 may have the same physical address, but since servers 16 and 22 have different identifiers, the DHCP server will be able to differentiate between the two client devices. If the physical address and the associated identifier match a corresponding pair of physical address and its associated identifier in the authorization database 12, the DHCP server 14 will determine that such request is from an authorized client device and will assign an IP address to the requesting client device (block 42), and return an IP address to the NAC server along arrow 44. This address is then provided to client 30 by the NAC server along arrow 46.

Thus, even if a hacker is able to fraudulently obtain the physical address of a particular client device, such as client device 18, he or she will be unable to obtain an IP address from the DHCP server 14. For example, if a hacker fraudulently obtains the physical address of client device 18 and sends a request for an IP address to server 16, using a clone client device 30, server 16 will reject the request since the physical addresses of client devices served and controlled by server 16 must be unique, and the physical address of the requesting clone client device 30 duplicates that of another client device 18 different from the requesting clone client device. The fact that the requesting clone client device 30 is an unauthorized clone may also be discovered. In a different scenario, the hacker may have obtained the physical address of client device 24 and sends the IP address request to server 16. Since client device 24 is outside of the group of client devices serviced and controlled by server 16, server 16 will not recognize the request as one from an unauthorized client device and will send along its own identifier with the IP request to the DHCP server 14.

As noted above, authorization database 12 will have stored therein the identifier of servers 16 and client device 18 as an associated pair and the identifier of server 22 and client device 24 as an associated pair. In the scenario above, the pair received by server 14, however, now consists of the identifier of server 16 and the physical address of client device 24, and this pair does not match any associated pair in the database 12. This mismatch would then be discovered by server 14 and the request for an IP address would be denied and not provided to server 16. Therefore, clone client devices will be unable to obtain an IP address from server 14 and will be unable to steal service from the network.

While the invention has been described above by reference to various embodiments, it will be understood that changes and modifications may be made without departing from the scope of the invention, which is to be defined only by the appended claims and their equivalents.

What is claimed is:

1. A method for enabling detection of unauthorized client devices during a process for providing an Internet Protocol address for a client device to access information on a network controlled by one or more network access control servers each having an identifier, comprising:
one of said one or more network access control servers receiving a request from a client device for an Internet Protocol address; and
said one network access control server transmitting said request with the identifier of said one network access control server to a DHCP server.

2. The method of claim 1, wherein the client device comprises a cable modem, and said one network access control server comprises a cable modem termination system.

3. The method of claim 2, wherein the identifier comprises a media access layer domain identifier of the cable modem termination system.

4. The method of claim 3, wherein the media access layer domain identifier comprises a unique media access layer domain number.

5. A method for providing Internet Protocol addresses for client devices to access information on a network controlled by one or more network access control servers each having an identifier; said method comprising:
receiving from one of said one or more network access control servers a request from a client device together with the identifier of said one network access control server;
determining from the identifier and a physical address of the client device whether the client device is an authorized client device; and
sending an Internet Protocol address to the client device only when it is determined that the client device is an authorized client device.

6. The method of claim 5, said method being performed by a DHCP server.

7. The method of claim 5, said determining including checking an authorization database that contains physical addresses and identifiers of authorized client devices.

8. The method of claim 5, wherein the client device comprises a cable modem, and said one network access control server comprises a cable modem termination system.

9. The method of claim 8, wherein the identifier comprises a media access layer domain identifier of the cable modem termination system.

10. The method of claim 9, wherein the media access layer domain identifier comprises a unique media access layer domain number.

11. The method of claim 9, said cable modem having a media access control address, wherein said determining includes checking the authenticity of the media access layer domain identifier of the cable modem termination system and of the media access control address of the cable modem.

12. A system for providing an Internet Protocol address for a client device to access information on a network, comprising:
one or more network access control servers each having an identifier and controlling access to the network; and
a DHCP server, each of the network access control servers transmitting requests from client devices for Internet Protocol addresses with the identifier of such one network access control server to the DHCP server, and the DHCP server determining from the identifier and physical address of each of at least some of the client devices whether such client device is an authorized client device, and sending an Internet Protocol address to such client device only when it is determined that such client device is an authorized client device.

13. The system of claim 12, further comprising an authorization database that contains physical addresses and identifiers of authorized client devices, wherein the said determining including checking the authorization database.

14. The system of claim 12, wherein the client devices comprise cable modems, and each of said network access control servers comprises a cable modem termination system.

15. The system of claim 14, wherein the identifier of each network access control server comprises a media access layer domain identifier of the cable modem termination system of such network access control server.

16. The system of claim 15, wherein the media access layer domain identifier comprises a unique media access layer domain number.

17. The system of claim 15, each of said cable modems having a media access control address, wherein said determining includes checking the authenticity of the media access layer domain identifiers of the cable modem termination systems and of the media access control addresses of the cable modems.
